(19) United States
(12) Patent Application Publication
(10) Pub. No.: US 2010/0206101 A1
(43) Pub. Date: Aug. 19, 2010

(54) Linear actuator

(75) Inventors: Chia-Ming Chang, Taichung City (TW); Hsin-An Chiang, Taichung City (TW); Ming-Hsin Liu, Taichung (TW)

Correspondence Address: CHARLES E. BAXLEY, ESQUIRE, 90 JOHN STREET, SUITE 309, NEW YORK, NY, 10038, US

(73) Assignee: Hiwin Mikrosystem Corp.

(21) Appl. No.: 12/378,797

(22) Filed: Feb. 19, 2009

(51) Int. Cl. F16H 21/00

(52) U.S. Cl. 74/25

(57) ABSTRACT

A linear actuator has a modulized structure that allows at least a transmission unit, an actuation unit, and a power device of the linear actuator to be combined integrally. The actuator is advantaged by its reduced manufacturing and fabricating costs, simplified and compact structure, as well as expanded application scope.

### BACKGROUND OF THE INVENTION

1. Technical Field

The present invention relates to linear actuators, and more particularly, to a linear actuator characterized in having a modulized structure wherein at least a transmission unit, an actuation unit, and a power device of the linear actuator are integrally assembled.

2. Description of Related Art

Linear actuators are extensively used as an economic and efficient means for applications where precise positioning control is required. For example, linear actuators provide manageable positioning control in antenna elevator systems, automatic wheelchairs, automatic hospital beds, massage chairs, rehabilitation devices and so on. A conventional linear actuator is typically made as a composite system composed of several separated parts, including connected transmission components, actuation components and a driving controller, plus a power device, peripheral control elements and a power supplier for driving the driving controller.

With the progress of the quality of life, apparatuses that need precise positioning control have been designed toward simple and compact structure. Consequently, it is desired that development of linear actuators caters for this trend. However, the conventional linear actuator in form of composite system is not only far from compactness, but also spoils the appearance of an apparatus using the same with its intertwined cables that are necessary for connecting the separate parts of the linear actuator. Hence, there is a need existing for a linear actuator that has an integral structure.

### SUMMARY OF THE INVENTION

In view of the shortcomings of the conventional linear actuator in form of composite system, the present invention provides a novel linear actuator that has a modulized structure that allows at least a transmission unit, an actuation unit, and a power device of the linear actuator to be combined integrally. The actuator is advantaged by its reduced manufacturing and fabricating costs, simplified and compact structure, as well as expanded application scope.

Therefore, one objective of the present invention is to provide a linear actuator that has a simplified and compact structure so as to avoid use of connecting cables or devices, thereby reducing manufacturing costs of the linear actuator.

Another objective of the present invention is to provide a linear actuator that has a simplified and compact structure wherein primary components are integrated as a whole so as to reduce the overall volume of the linear actuator.

Another objective of the present invention is to provide a linear actuator that has a simplified and compact structure and is thus extensively applicable to various apparatuses that need precise positioning control.

Still another objective of the present invention is to provide a linear actuator that has a simplified and compact structure and is thus easy to install and maintain so as to save time and energy traditionally consumed by assembling and wiring works for the conventional linear actuator, thereby enhancing efficiency of installation and maintenance, and reducing labor and time costs.

To achieve these and other objectives of the present invention, the linear actuator of the present invention primarily comprises:

a power device, enclosed in a first housing and providing a driving force of a first direction;

a transmission unit, enclosed in a second housing and driven by the power device to convert the driving force of the first direction to a driving force of a second direction; and

an actuation unit, enclosed in the second housing, having a pushing shaft connected with the transmission unit, and driven by the driving force of the second direction from the transmission unit to extend or retract the pushing shaft;

wherein the first housing and the second housing are combined to have an integrated appearance.

According to one aspect of the present invention, the first housing further comprises a body and a cap, wherein the body and the cap may be detachably coupled with each other by any known means, such as, but not limited to grooves and matching tenons formed on the body and the cap, respectively.

According to one aspect of the present invention, the power device is a stepping motor.

According to one aspect of the present invention, the linear actuator further comprises a driving controller received in the first housing for controlling the power device to output the driving force of the first direction to the transmission unit.

According to one aspect of the present invention, the linear actuator further comprises a power supplier received in the first housing for supplying a power current to the power device.

According to one aspect of the present invention, the linear actuator further comprises a control box allowing a user to control the driving controller thereby.

According to one aspect of the present invention, the linear actuator further comprises a control box allowing a user to control the power supplier thereby.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is a perspective view of a linear actuator of the present invention;

FIG. 2 is an exploded view of the linear actuator of the present invention;

FIG. 3 is a schematic drawing of the linear actuator of the present invention showing the cap opened; and

FIG. 4 is an applied view of the linear actuator of the present invention showing the same installed in a box for lifting a lid of the box.

### DETAILED DESCRIPTION OF THE PREFERRED EMBODIMENTS

While the present invention proposes a linear actuator for positioning control, the control principles thereof are known to one skilled in the art and need not be discussed at any length herein. Meanwhile, the accompanying drawings referred to in the following description are provided for illustrative purposes and need not to be made to scale.

It is known in the art that a linear actuator is composed of a power device, a transmission unit and an actuation unit that are connected mutually. The power device is typically a motor. According to one aspect of the present invention, the power device is a stepping motor so as to achieve enhance positioning control. The power device services to provide a driving force of a first direction, and the driving force of the first direction can drive the transmission unit under control of a driving controller. The driving force of the first direction is then converted into a driving force of a second direction by the transmission unit to drive a pushing shaft of the actuation unit so that the actuation unit can extend or retract the pushing shaft and in turn push or draw an external object, thereby achieve desired positioning control.

As described previously, the present invention provides a linear actuator having a modulized structure wherein a transmission unit, an actuation unit, a driving controller, a power device, peripheral control elements and a power supplier are integrated. The actuator is advantageous for its reduced manufacturing and fabricating costs, simplified and compact structure, as well as expanded application scope.

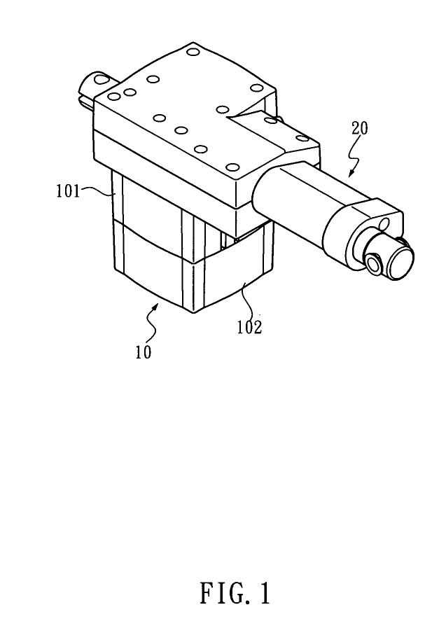

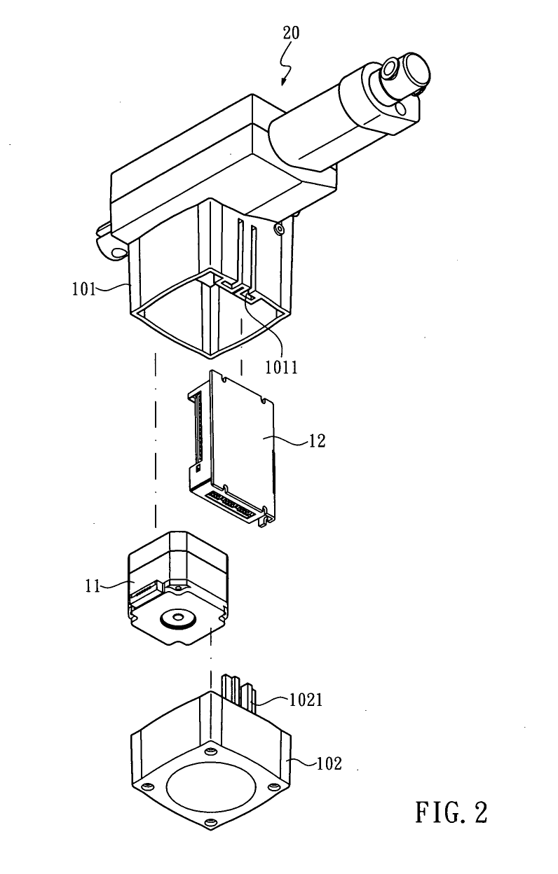

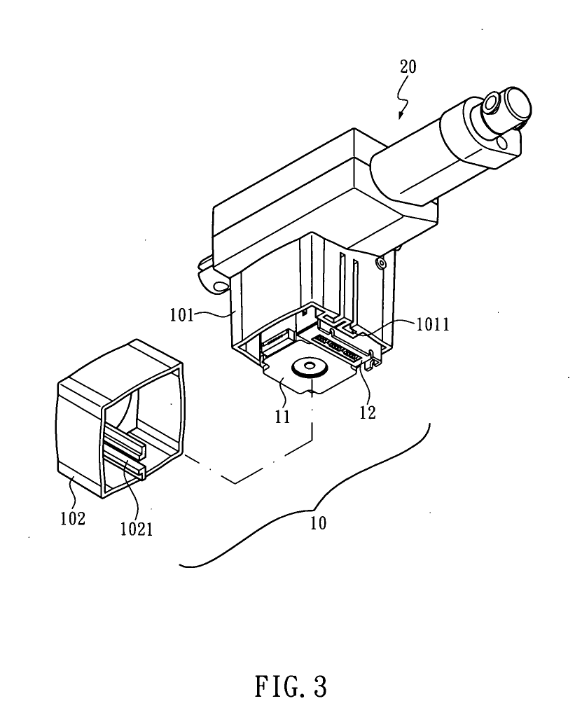

Thus, referring to FIGS. 1 through 3, according to one embodiment of the present invention, a power device 11 and a driving controller 12 are enclosed in a first housing 10 while a transmission unit and an actuation unit (not shown) are enclosed in a second housing 20. The first housing 10 and the second housing 20 are combined as a whole piece so as to realize an integrated structure of the linear actuator.

According to practical needs, the first housing 10 may accommodate other components related to operation of the linear actuator, such as peripheral controlling elements or a power supplier.

Besides, as can be seen in the drawings, the first housing further 10 comprises a body 101 and a liftable cap 102, wherein the body 101 and the liftable cap 102 may be detachably coupled with each other by any known means, such as, but not limited to grooves 1011 and matching tenons 1021 formed on the body 101 and the liftable cap 102, respectively, so as to facilitate maintenance of the power device 11 and the driving controller 12.

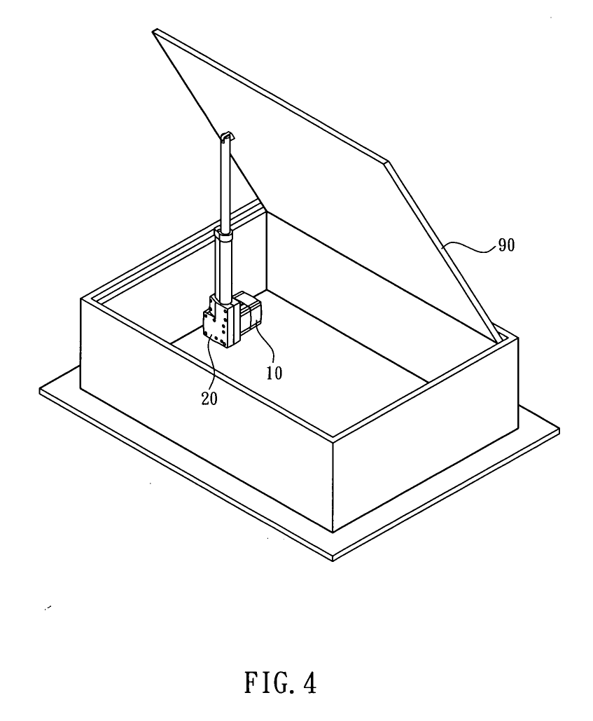

When the linear actuator is installed in a box 90 where an automatic lid-lifting function is required, as shown in FIG. 4, the integrated, modular structure of the linear actuator eliminates use of cables or means for connecting separate parts of a traditional linear actuator. Consequently, the present invention significantly reduces manufacturing costs of the liner actuator and saves labor and time for installing and maintaining the liner actuator. As a result, the linear actuator of the present invention can be applied more extensively to various applications.

In addition, the linear actuator may further comprise a control box (not shown) that allows a user to control the driving controller and the power supplier thereby. The control box may, under consideration of installation environment and operational convenience, be attached to the first housing or the second housing or settled independently from the first housing and the second housing.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A linear actuator, comprising:
a power device, enclosed in a first housing and providing a driving force of a first direction;
a transmission unit, enclosed in a second housing and driven by the power device to convert the driving force of the first direction to a driving force of a second direction; and
an actuation unit, enclosed in the second housing, having a pushing shaft connected with the transmission unit, and driven by the driving force of the second direction from the transmission unit to extend or retract the pushing shaft;
wherein the first housing and the second housing are combined to have an integrated appearance.

2. The linear actuator of claim 1, wherein the first housing further comprises a body and a liftable cap.

3. The linear actuator of claim 2, wherein the body and the liftable cap are detachably coupled by grooves and matching tenons formed on the body and the cap, respectively.

4. The linear actuator of claim 1, wherein the power device is a stepping motor.

5. The linear actuator of claim 1, further comprising a driving controller received in the first housing for controlling the power device to output the driving force of the first direction to the transmission unit.

6. The linear actuator of claim 5, further comprising a control box allowing a user to control the driving controller thereby.

7. The linear actuator of claim 1, wherein a power supplier received in the first housing supplies a power current to the power device.

8. The linear actuator of claim 7, further comprising a control box allowing a user to control the power device thereby.
